(19) United States
(12) Patent Application Publication
(10) Pub. No.: US 2010/0276835 A1
(43) Pub. Date: Nov. 4, 2010

(54) Method of Manufacturing an Air Hole of Hollow Fiber Membrane Module for Water Treatment

(76) Inventors: Soon Hyuk Im, Seoul (KR); Tae Duog Lee, Gyeonggi-do (KR); Sung Su Bae, Gyeonggi-do (KR); Seong Hoe Koo, Gyeonggi-do (KR); Tae Jeong Kim, Gyeonggi-do (KR); Sang Hoon Kim, Gyeonggi-do (KR); Hang Duk Rho, Gyeonggi-do (KR); Sung Du Leem, Gyeonggi-do (KR); Yong Hee Yoo, Gyeonggi-do (KR); Hyung Jin Jun, Gyeonggi-do (KR)

Correspondence Address: FROMMER LAWRENCE & HAUG, 745 FIFTH AVENUE- 10TH FL., NEW YORK, NY, 10151, US

(21) Appl. No.: 11/993,041

(22) PCT Filed: Jun. 20, 2006
(86) PCT No.: PCT/KR06/02358

§ 371 Date: Jul. 20, 2010

(30) Foreign Application Priority Data
Jun. 23, 2005 (KR) 10-2005-0054223

(51) Int. Cl. B32B 1/08

(52) U.S. Cl. 264/171.13

(57) ABSTRACT

The present invention relates to a method of forming air holes in a hollow fiber membrane module for water treatment. A main object of the present invention is to easily form air holes in the potting material injected into the module housing to prevent contamination of the hollow fiber membranes in the module housing. Accordingly, the present invention provides a method of forming air holes in a hollow fiber membrane module for water treatment, in which a plurality of pins and a disc-like plate, to which distal ends of the pins are fit, are disposed at one end portion of the inside of the module housing, the pins and the plate are immersed in the potting material (adhesive agent) during the potting process, the bonding mold is first removed from the module housing after the potting process and the plate is separated from the pins, and simultaneously the rear ends of the pins exposed to the outside are pulled outwardly to be removed from the potting material such that a plurality of air holes are formed at the corresponding empty positions of the potting material from which the pins are removed.

### TECHNICAL FIELD

The present invention relates to a method of forming air holes in a hollow fiber membrane module for water treatment, and more particularly, to such an air hole-forming method in which the hollow fiber membrane module is easily formed internally with air holes for supplying air toward the hollow fiber membranes therethrough using a circle plate and a plurality of pins during the potting process of an adhesive to allow contaminants accumulated on the surfaces of hollow fiber membranes in a hollow fiber membrane module to be subjected to a physical cleaning using air.

### Background Art

In general, a hollow fiber membrane module is widely used for the treatment of filtering membranes, water purification, elimination of pollutants from sewage, etc., in various industrial fields, environmental fields and the like.

Of these, the hollow fiber membrane module is especially useful in the water treatment field such as drinking water or sewage treatment. Further, there has been a demand for a large-sized hollow fiber membrane module to reduce the cost for water treatment.

The essential constitutional elements of the hollow fiber membrane module are as follows.

First, the hollow fiber membrane module comprises a module housing formed in a cylindrical shape, a hollow fiber membrane bundle including a plurality of layers of hollow fiber membranes disposed within the module housing, a potting material (adhesive agent) used for adhesively fixing both ends (upper and lower ends) or one end of the hollow fiber membrane bundle, upper and lower collectors mounted at the upper and lower portions of the module housing, and an air diffuser for eliminating contaminants accumulated on the surfaces of the hollow fiber membranes.

This kind of a hollow fiber membrane module can be classified into two types. One is a type in which a treated-water collector is disposed at the upper and lower portions of the hollow fiber membrane module, respectively, i.e., the hollow fiber membrane bundle is fixed at the upper and lower ends thereof to the upper and lower collectors, respectively, by means of a potting material (adhesive agent). The other is a type in which the treated-water collector is disposed at one side of the hollow fiber membrane bundle, i.e., the hollow fiber membrane bundle is fixed at a lower end thereof to the treated-water collector by means of the potting material and is formed at an upper end thereof with a fixed end.

The water treatment process of the above hollow fiber membrane module will be briefly described hereinafter.

Raw water is introduced into the hollow fiber membrane bundle from the outside and is filtrated in the hollow fiber membrane. The filtrated water is collected in the upper collector while flowing along the inside of the hollow fiber membrane bundle, and is then discharged to be subjected to a post-treatment process.

In the above filtering process, when the raw water is filtrated inside the hollow fiber membrane bundle while passing through the hollow fiber membranes, the pollutants contained in the raw water are accumulated on the surfaces of the hollow fiber membranes. Therefore, it is very important in the hollow fiber membrane module that such pollutants are separated and removed to sustainably maintain the physical separation of the hollow fiber membranes.

Consequently, to eliminate the contaminants accumulated on the hollow fiber membranes, an air diffuser is mounted at a lower portion of the module housing.

The air diffuser includes an air supply unit and air holes which are penetratingly formed at the potting material (adhesive agent) where a lower end of the hollow fiber membrane bundle is molded.

Therefore, air supplied from the air supply means is injected toward the hollow fiber membranes disposed in the module housing through the air holes formed in the potting material. At this time, the injected air induces a cross flow of water and generates a physical shaking (i.e., vibration is applied to the hollow fiber membranes) while creating air bubbles, thereby separating and eliminating the contaminants accumulated on the surfaces of the hollow fiber membranes (separation membranes).

In case of a large-scaled hollow fiber membrane module (having an ID of more than 160 mm), an air scrubbing is used to subject the hollow fiber membranes to the physical cleaning as described above. To this end, an air-hole structure is formed at the lower portion of the module housing during the potting process.

A conventional method of forming the air holes during the potting process, i.e., the process of integrally sealing the potting material (adhesive agent) in the hollow fiber membrane module has been disclosed in Japanese Patent Laid-Open Publication Nos. 2004-49986 and 2004-5001.

In the above Japanese patent applications, the air holes are formed during the potting process of a large-scaled case-in type hollow fiber membrane module.

That is, for construction of the air-hole structure at the lower portion of the module housing, a plurality of pins are mounted at an inner distal end of the module housing. At this time, the rear end of each pin is exposed to the outside while passing through a bonding mold (means for sealing both ends of the module housing), and then a potting material is charged into the module housing and simultaneously the module housing rotates about its central vertical axis at a certain speed.

Then, the potting material charged into the module housing is more densely concentrated at both end portions of the module housing by means of a centrifugal force, while being more sparsely concentrated in a direction toward the central portion of the module housing. At the same time, when the pins are molded adhesively and then the molded pins are removed at a post process, the air holes are just formed at the corresponding empty positions of the potting material where the pins are removed.

However, the conventional air hole forming method performed during such a potting process has the following drawbacks.

First, since the rear ends of the pins arranged inside the module housing are kept in a state of being exposed to the outside while passing through the bonding mold, there may occur a phenomenon in which the pins are escaped from the potting material by means of the centrifugal force according to the rotation of the module housing during the potting process.

In an effort to prevent the escape of the pins, the rear ends of the pins that have passed through the potting material and the bonding mold must be fixedly molded by means of another molding material, which contributes to complexity and burdensomeness in the manufacturing process of the hollow fiber membrane module.

### DISCLOSURE

### Technical Problem

Accordingly, the present invention has been made in view of the above problems occurring in the prior art, and it is an object of the present invention to provide a method of forming air holes in a hollow fiber membrane module for water treatment, in which a plurality of pins and a circle plate, to which distal ends of the pins are fit, are disposed at one end portion of the inside of the module housing in such a fashion that the pins and the plate are in close contact with the inner surface of the bonding mold at the outer surfaces thereof, the pins and the plate are immersed in the potting material (adhesive agent) during the potting process, the bonding mold is first removed from the module housing after the potting process and the plate is separated from the pins, and simultaneously the rear ends of the pins exposed to the outside are pulled outwardly so as to be removed from the potting material such that a plurality of air holes are formed at the corresponding empty positions of the potting material from which the pins are removed.

### TECHNICAL SOLUTION

To accomplish the above object, according to the present invention, there is provided a method of forming air holes in a hollow fiber membrane module for water treatment, the method including the steps of: fittingly coupling the rear ends of a plurality of pins to a plate to form an assembly of the pins and the plate; disposing a hollow fiber membrane bundle including a plurality of layers of hollow fiber membranes within a cylindrical module housing, and simultaneously coupling the assembly of the pins and the plate to one end portion of the inside of the module housing; coupling a bonding mold to both ends of the cylindrical module housing to enclose the module housing; horizontally placing the module housing, charging a potting material (adhesive agent) into the module housing through injecting ports formed on an outer circumferential surface of the upper portion of the module housing, and simultaneously rotating the module housing about a vertical central axis of the module housing; allowing the potting material charged into the module housing to be more densely concentrated at both end portions of the module housing by means of a centrifugal force according to the rotation of the module housing so as to cause both end portions of the hollow fiber membrane bundle and the plural pins to be immersed in the potting material; solidifying the potting material in a state where the both end portions of the hollow fiber membrane bundle and the plural pins are embedded in the potting material during the immersion process, and removing the bonding mold from the module housing and simultaneously separating the plate from the rear ends of the plural pins to expose the rear ends of the pins to the outside; and outwardly pulling the rear ends of the pins exposed to the outside using a certain separation means so as to form a plurality of air holes at the corresponding empty positions of the potting material from which the pins are removed.

In a preferred embodiment, an iron core may be inserted into a separation hole penetratingly formed at the rear end of each of the pins, and is then turned for interface separation of each pin from the potting material.

In a more preferred embodiment, each of the pins may be formed of any one selected from the group consisting of plastic, aluminum, stainless steel and iron.

Further, preferably, the plate may be formed in a disc-shape, has an outer diameter conforming to the contour of a recess formed in the inner surface of the bonding mold so as to be seated in the recess, and is equidistantly formed thereon with a plurality of through-holes for fittingly coupling the plural pins thereto.

### [Advantageous Effects]

A method of forming air holes in a hollow fiber membrane module for water treatment according to the present invention has an advantageous effect in that the plate and the pins fittingly coupled to the plate are arranged inside the module housing, and the pins are immersed in the potting material (adhesive agent) and are then separated from the potting material after the potting process so as to easily form the air holes at the corresponding empty positions of the potting material from which the pins are removed.

Particularly, the inventive air hole-forming method has a merit in that it is very easily performed to thereby greatly reduce the manufacturing cost as compared to a conventional complex and burdensome air hole-forming method in which the rear ends of the pins is fixedly molded by means of another molding material

### DESCRIPTION OF DRAWINGS

FIG. 1 is a front view illustrating the structure of a pin used in a method of forming air holes in a hollow fiber membrane module for water treatment according to the present invention;

FIG. 2 is a top plan and cross-sectional view illustrating the structure of a plate used in a method of forming air holes in a hollow fiber membrane module for water treatment according to the present invention; and

FIGS. 3 to 6 are cross-sectional views sequentially illustrating a method of forming air holes in a hollow fiber membrane module for water treatment according to the present invention.

### MODE FOR INVENTION

Hereinafter, the present invention will be described in detail with reference to the accompanying drawings.

The present invention is directed to a method of forming the air holes during the potting process, i.e., the process of integrally sealing the potting material (adhesive agent), of a large-sized case-in type hollow fiber membrane module. In this case, such a large-sized hollow fiber membrane module (having an ID of more than 160 mm) typically employs an air scrubbing technique to subject the hollow fiber membranes to the physical cleaning. Accordingly, an air-hole structure must be formed at the lower portion of the module housing during the potting process. Thus, the present invention is aimed at providing a method of forming air holes during the potting process.

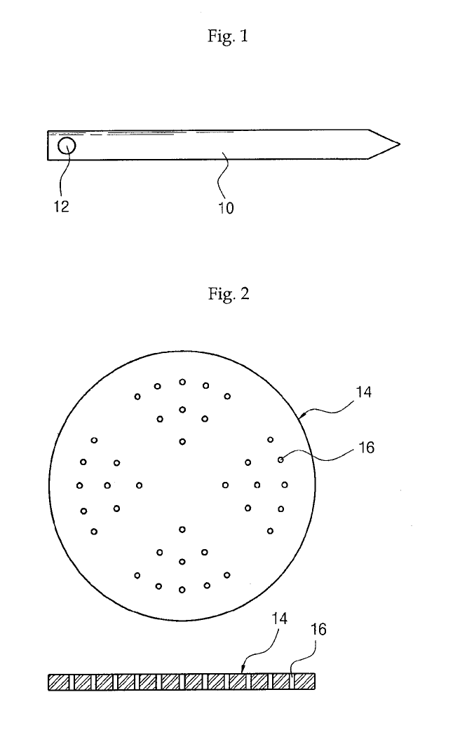

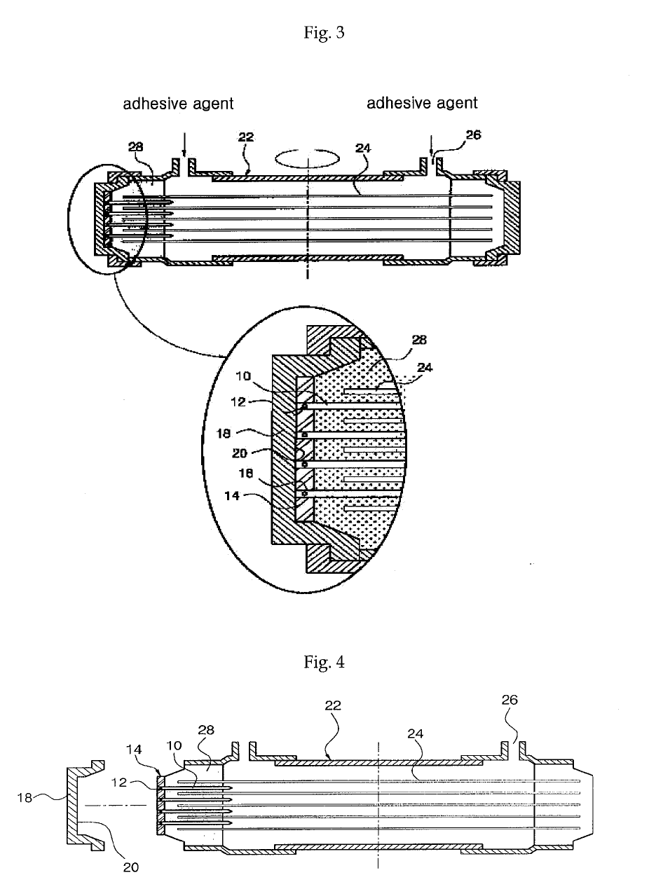

FIGS. 1 and 2 illustrate the structures of a pin and a plate used in a method of forming air holes in a hollow fiber membrane module for water treatment according to the present invention.

Referring to FIGS. 1 and 2, the pin 10 has an elongated structure formed of any one selected from the group consisting of plastic, aluminum, stainless steel and iron. The pin is manufactured in a rod shape having a length of 60 to 180 mm and an outer diameter of 5 to 20 mm.

More specifically, the pin 10 has a sharp point formed at a front end thereof, and has with a separation hole 12 penetratingly formed at a rear end thereof in such a fashion as to be oriented vertically with respect to the longitudinal direction of the pin 10 to be used to disconnect the pin from the potting material.

In case of making the pin 10 of a plastic material, the pin is preferably made of any one selected from the group consisting of polyethylene (PE), polyprophylene (PP), acetal, Tefron, M/C, and polyvinyl chloride (PVC).

Under the construction for forming air holes in the hollow fiber membrane module according to the present invention, a plate 14 is further provided along with the pin 10. The plate 14 is formed in a disc shape and has a plurality of through-holes 16 formed thereon.

In addition, the disc-like plate 14 is seated in a recess 20 formed in the inner surface of the bonding mold 18 in a state of being in close contact with the recess during the air hole forming process. In this case, the plate 14 preferably has an outer diameter conforming to the contour of the recess 20 of the bonding mold 18 so as to be seated in the recess.

Therefore, in order to form the air holes in the hollow fiber membrane module according to the present invention, the rear end of the pin 10 (i.e., a portion where the separation hole 12 is formed) is fit into the through-hole 16 of the plate 14 so as to allow the pin 10 and the plate 14 to be integrally formed with each other for use.

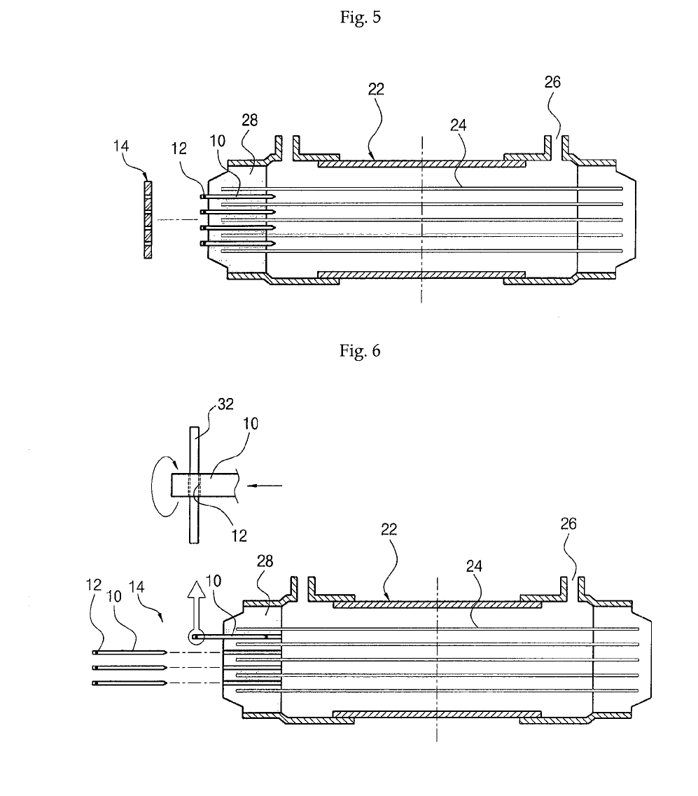

Now, a process of forming the air holes in the hollow fiber membrane module using the plastic pin as constructed above according to the present invention will be described hereinafter in detail with reference to FIGS. 3 to 6.

FIGS. 3 to 6 are cross-sectional views sequentially illustrating a method of forming air holes in a hollow fiber membrane module for water treatment according to the present invention.

Referring to the drawings, a hollow fiber membrane bundle including a plurality of layers of hollow fiber membranes 24 is disposed within a cylindrical module housing 22. At this time, the hollow fiber membrane bundle is closed at one side thereof and opened at the other side thereof.

As an embodiment of the present invention, hollow fiber membranes 24 of sixteen thousand strands are disposed inside the module housing 22 having an inner diameter of 200 mm. Thereafter, thirty rod-shaped aluminum pins 10, each having a length of 60 to 180 mm and an outer diameter of 5 to 20 mm, preferably a length of 150 mm and an outer diameter of 10 mm, are arranged at an opened side (the lower end portion of the module housing) of the hollow fiber membrane bundle. In this case, the pins 10 are uniformly distributed between the respective strands of the hollow fiber membranes 24.

At this time, the corresponding through-holes 16 of the plate 14 are fit around the rear ends of the pins 10 arranged between the strands of the hollow fiber membranes 24.

That is, the rear ends (portions where the separation holes 12 are formed) of the pins 10 are fittingly coupled to the corresponding through-holes 16 of the plate 14 so as to allow the pins 10 and the plate 14 to be integrally formed with each other.

Then, a bonding mold 18 is coupled to both ends of the cylindrical module housing 22 to enclose the module housing. At this time, the outer circumferential surface of the plate 14 is in close contact with the inner circumferential surface of the recess 20 of the bonding mold 18.

Subsequently, as shown in FIG. 3, after the module housing 22 has been placed horizontally, a potting material 28 (adhesive agent) is charged into the module housing 22 through injecting ports 26 formed on an outer circumferential surface of the upper portion of the module housing, and simultaneously the module housing 22 rotates about a vertical central axis of the module housing 22 at a certain speed.

Consequently, the potting material 28 charged into the module housing 22 is more densely concentrated at both end portions of the module housing 22 by means of a centrifugal force according to the rotation of the module housing 22 while being more sparsely concentrated in a direction toward the central portion of the module housing 22 so as to cause both end portions of the hollow fiber membrane bundle and the plural pins 10 to be immersed in the potting material 28.

After the potting material 28 has been solidified in a state where the both end portions of the hollow fiber membrane bundle and the pins 10 are embedded in the potting material 28 during the immersion process, as shown in FIGS. 4 and 5, the bonding mold 18 is removed from the module housing 22 and simultaneously the plate is separated from the rear ends of the pins 10. At this time, the rear ends of the pins 10 are exposed to the outside.

Next, as shown in FIG. 6, the rear ends of the pins 10 exposed to the outside are outwardly pulled by using a certain separation means so as to form air holes 30 at the corresponding empty positions of the potting material from which the pins are removed.

That is, an iron core 32 is inserted into a separation hole 12 penetratingly formed at the rear end of each of the pins 10, and is then turned for interface separation of each pin 10 from the potting material 28. At this time, when the pin 10 in a state of interface separation is pulled outwardly, it is completely separated from the potting material 28 so that air hole 30 is formed at the corresponding position of the potting material 28 from which the pin 10 is removed.

Resultantly, as the pins 10 are separated from the potting material 28, the air holes 30 are formed at the corresponding empty positions of the potting material 28 from which the pins 10 are removed. As an embodiment, thirty-six aluminum pins 10 are separated from the potting material 28 one by one so that thirty-six air holes 30 for supplying air between the hollow fiber membranes 24 therethrough can be formed.

Accordingly, air supplied from an air supply means is sprayed toward the hollow fiber membranes 24 disposed in the module housing 22 through the air holes 30 formed in the potting material 28 to form air bubbles. At this time, the sprayed air induces a cross flow of water and generates a physical shaking (i.e., vibration is applied to the hollow fiber membranes) while creating air bubbles, thereby to separate and eliminate the contaminants accumulated on the surfaces of the hollow fiber membranes (separation membranes).

### Industrial Applicability

Therefore, a method of forming air holes in a hollow fiber membrane module for water treatment according to the present invention has an advantage that the plate and the pins fittingly coupled to the plate are arranged inside the module housing, and the pins are immersed in the potting material (adhesive agent) and are then separated from the potting material after the potting process so as to easily form the air holes at the corresponding empty positions of the potting material 28 from which the pins 10 are removed.

Particularly, the inventive air hole-forming method has a merit in that it is very easily performed to thereby greatly reduce the manufacturing cost as compared to a conventional complex and burdensome air hole-forming method in which the rear ends of the pins is fixedly molded by, means of another molding material.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of forming air holes in a hollow fiber membrane module for water treatment, the method comprising the steps of:
fittingly coupling the rear ends of a plurality of pins to a plate to form an assembly of the pins and the plate;
disposing a hollow fiber membrane bundle including a plurality of layers of hollow fiber membranes within a cylindrical module housing, and simultaneously coupling the assembly of the pins and the plate to one end portion of the inside of the module housing;
coupling a bonding mold to both ends of the cylindrical module housing to enclose the module housing;
horizontally placing the module housing, charging a potting material (adhesive agent) into the module housing through injecting ports formed on an outer circumferential surface of the upper portion of the module housing, and simultaneously rotating the module housing about a vertical central axis of the module housing;
allowing the potting material charged into the module housing to be more densely concentrated at both end portions of the module housing by means of a centrifugal force according to the rotation of the module housing so as to cause both end portions of the hollow fiber membrane bundle and the plural pins to be immersed in the potting material;
solidifying the potting material in a state where the both end portions of the hollow fiber membrane bundle and the plural pins are embedded in the potting material during the immersion process, and removing the bonding mold from the module housing and simultaneously separating the plate from the rear ends of the plural pins to expose the rear ends of the pins to the outside; and
outwardly pulling the rear ends of the pins exposed to the outside using a certain separation means so as to form a plurality of air holes at the corresponding empty positions of the potting material from which the pins are removed.

2. The method as defined in claim 1, wherein an iron core is inserted into a separation hole penetratingly formed at the rear end of each of the pins, and is then turned for interface separation of each pin from the potting material.

3. The method as defined in claim 1, wherein each of the pins is formed of any one selected from the group consisting of plastic, aluminum, stainless steel and iron.

4. The method as defined in claim 1, wherein the plate is formed in a disc-shape, has an outer diameter conforming to the contour of a recess formed in the inner surface of the bonding mold so as to be seated in the recess, and is uniformly formed thereon with a plurality of through-holes for fittingly coupling the plural pins thereto.

5. The method as defined in claim 2, wherein each of the pins is formed of any one selected from the group consisting of plastic, aluminum, stainless steel and iron.
